(19) United States
(12) Patent Application Publication
(10) Pub. No.: US 2018/0250993 A1
(43) Pub. Date: Sep. 6, 2018

(54) TRAILER COUPLER WITH HITCH BALL INSERTION INDICATOR

(71) Applicant: LIPPERT COMPONENTS, INC., Elkhart, IN (US)

(72) Inventor: Andrew WENTLAND, Framingham, MA (US)

(21) Appl. No.: 15/907,392

(22) Filed: Feb. 28, 2018

Related U.S. Application Data
(60) Provisional application No. 62/467,507, filed on Mar. 6, 2017.

(51) Int. Cl. B60D 1/24; B60D 1/06

(52) U.S. Cl. CPC B60D 1/24; B60D 1/065

(57) ABSTRACT

A hitch ball-type trailer coupler having a coupler body defining a cavity includes first and second indicator pin guides slidingly receiving respective indicator pins. Each of the indicator pins is slideable between extended and retracted positions, and biased to the retracted position. The coupler is configured for use with a correspondingly-sized hitch ball. Insertion of the correspondingly-sized hitch ball fully into the cavity causes both of the first and second indicator pins to be extended by at least a predetermined amount. Insertion of an undersized hitch ball into the cavity does not cause both of the first and second indicator pins to be extended by at least the predetermined amount.

### CROSS-REFERENCE TO RELATED APPLICATION

This application claims benefit under 35 U.S.C. § 119 of U.S. Provisional Patent Application No. 62/467,507, filed on Mar. 6, 2017, and incorporates by reference the disclosure thereof in its entirety.

### BACKGROUND AND SUMMARY OF THE DISCLOSURE

Hitch ball-type trailer coupler systems are known in the art. Such systems include a hitch ball attached to a tow vehicle (typically through an intervening ball mount and hitch) and a coupler attached to the tongue of a trailer. In use, the coupler is lowered onto the hitch ball, and a latching mechanism integral with the coupler latches the coupler to the hitch ball.

Such hitch balls are available in several sizes, for example, 1⅞ inch, 2 inch, and 2 5/16 inch diameters. Such hitch balls may be available in other sizes, as well. Such trailer couplers are available in sizes corresponding to the hitch ball sizes. The ball size and coupler size must be properly matched. Physical constraints typically preclude an oversized ball from being partially or fully inserted into a given coupler. An undersized ball can be easily inserted into a given coupler, but physical constraints typically preclude securely latching a given coupler onto an undersized ball.

Winterhoff GmbH of Breckerfeld, Germany, markets a hitch ball-type trailer coupler that includes an indicator pin that may be actuated by the hitch ball, such that indicator pin extends vertically from the coupler body when the coupler is lowered onto the hitch ball. When the coupler is removed from the hitch ball, the indicator pin is retracted into the coupler body. Although this coupler may provide visual indication of the presence of a hitch ball within the coupler, it does not indicate whether such a hitch ball is properly sized. For example, an undersized hitch ball could actuate the indicator pin in the same manner as a properly-sized hitch ball.

### BRIEF DESCRIPTION OF THE DRAWINGS

FIG. 1 is a perspective view of a hitch ball coupler having first and second indicator pins according to the present disclosure, with no hitch ball inserted in the coupler and the first and second indicator pins fully retracted;

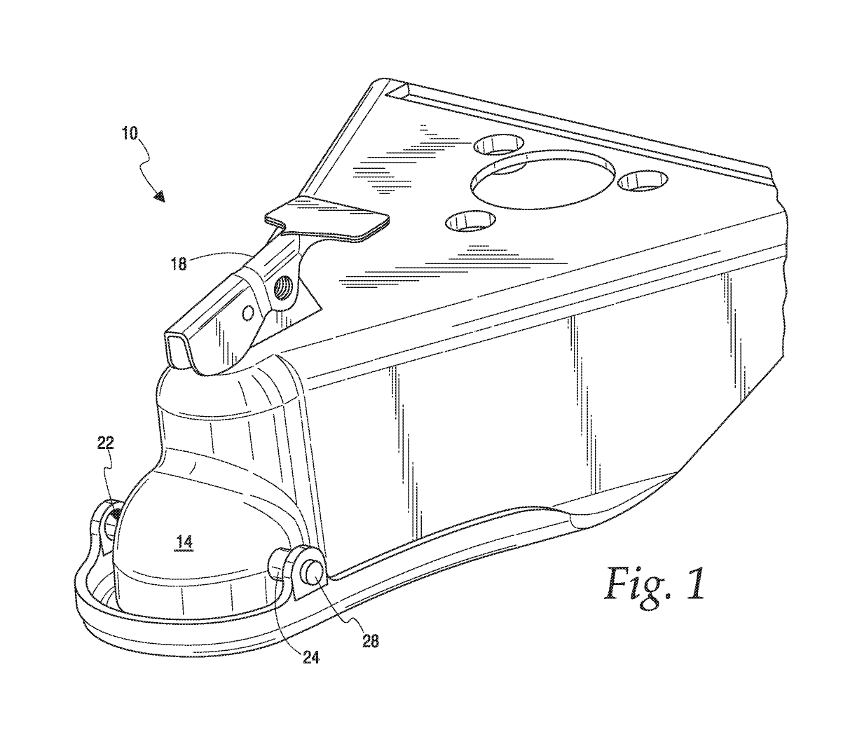

FIG. 2 is a front elevation view of the hitch ball coupler of FIG. 1 with no hitch ball inserted in the coupler and the first and second indicator pins fully retracted;

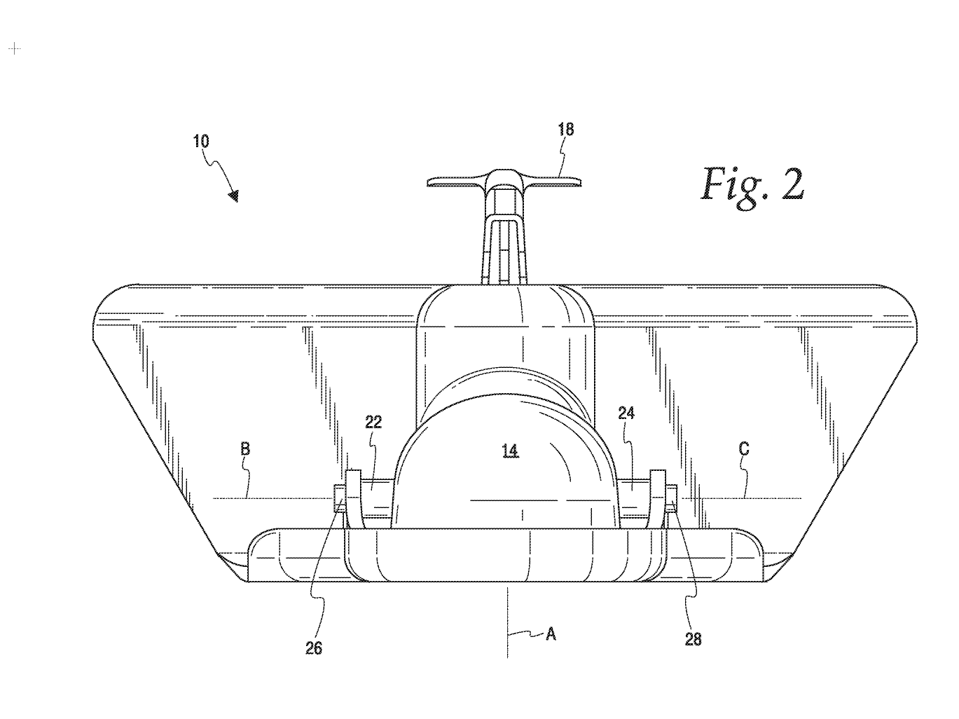

FIG. 3 is a bottom plan view of FIG. 1 with no hitch ball inserted in the coupler and the first and second indicator pins fully retracted;

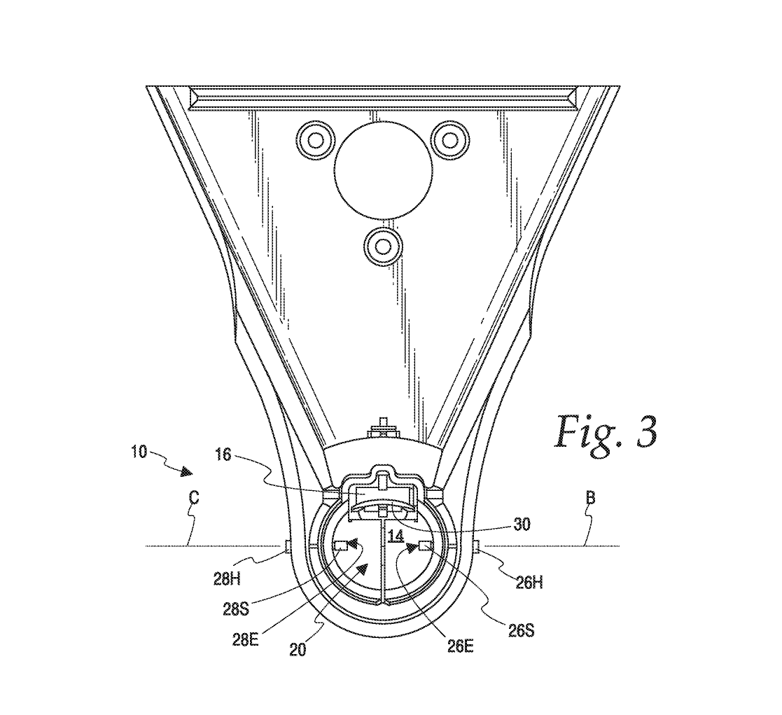

FIG. 4 is a front elevation view of the hitch ball coupler of FIG. 1 with an undersized hitch ball inserted in the coupler and the first and second indicator pins fully retracted;

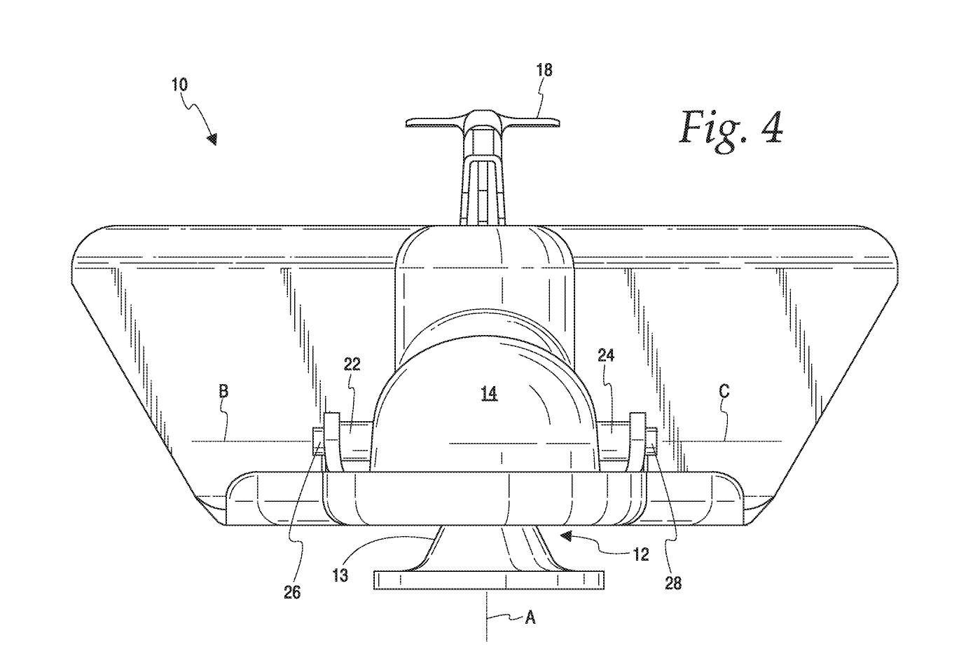

FIG. 5 is a perspective view of the hitch ball coupler of FIG. 1 with a properly sized hitch ball inserted in the coupler and the first and second indicator pins fully extended;

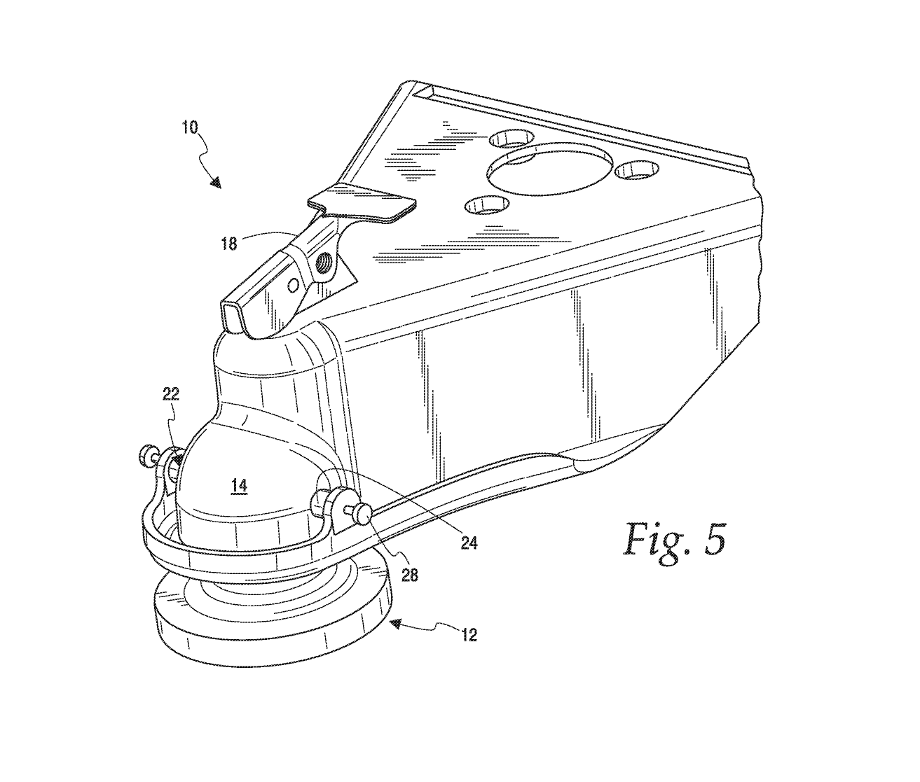

FIG. 6 is a front elevation view of the hitch ball coupler of FIG. 1 with a properly sized hitch ball inserted in the coupler and the first and second indicator pins fully extended;

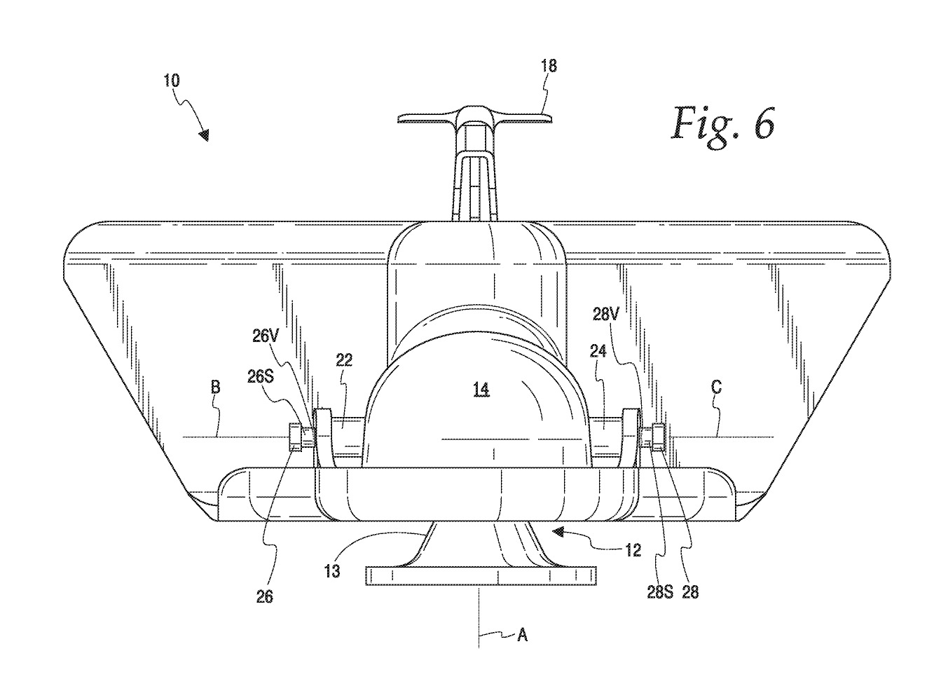

FIG. 7 is a bottom plan view of FIG. 1 with a properly sized hitch ball inserted in the coupler and the first and second indicator pins fully extended;

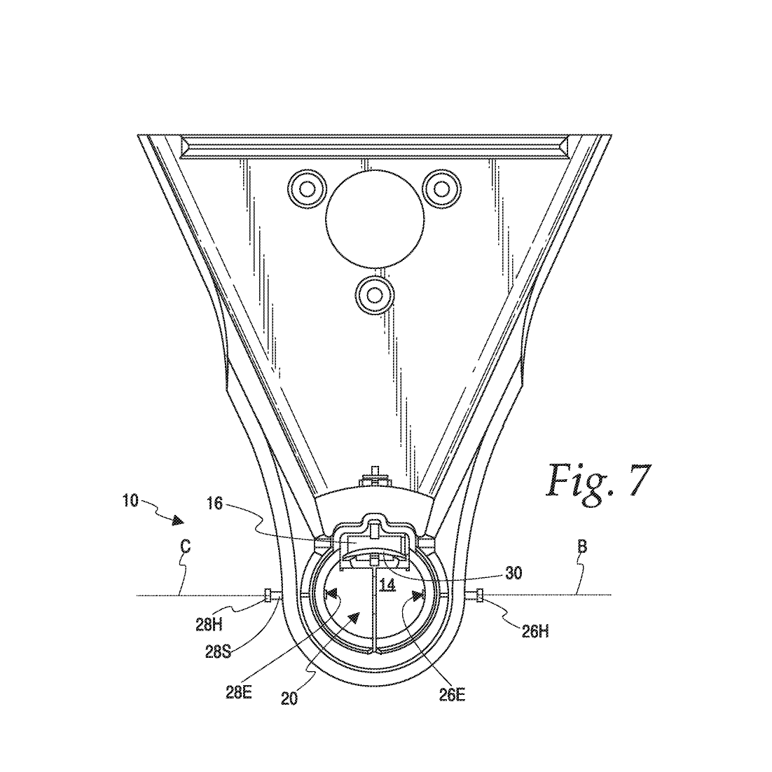

FIG. 8 is a cut-away front elevation view of the hitch ball coupler of FIG. 1 with no hitch ball inserted in the coupler and the first and second indicator pins fully retracted;

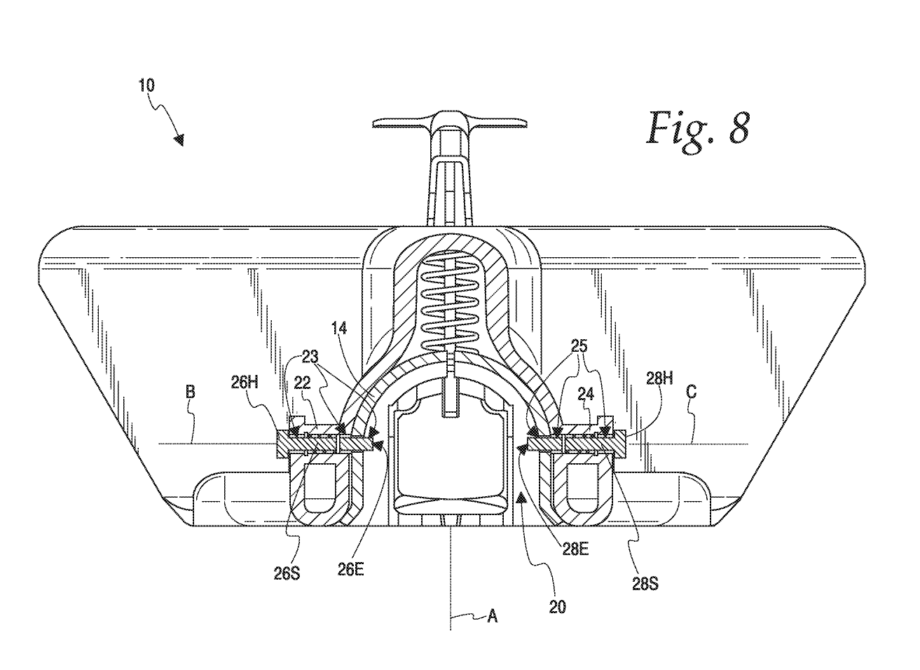

FIG. 9 is a cut-away front elevation view of the hitch ball coupler of FIG. 1 with a hitch ball inserted in the coupler and the first and second indicator pins fully extended; and

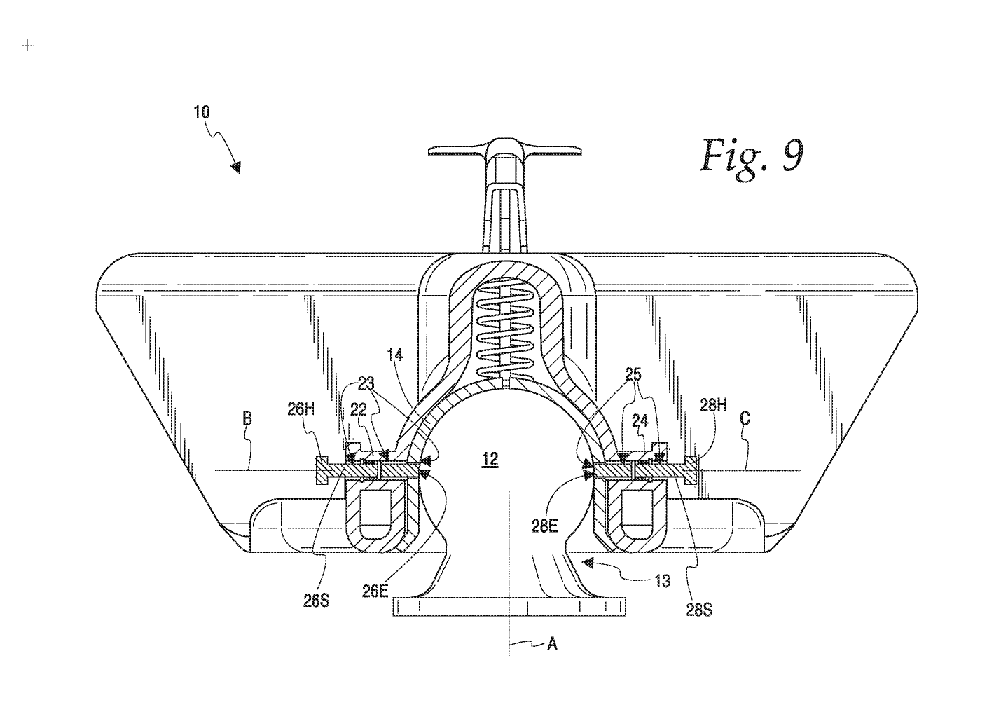

FIG. 10 is a partial cut-away front elevation view of the hitch ball coupler of FIG. 1 with no hitch ball inserted in the coupler and the first and second indicator pins fully retracted.

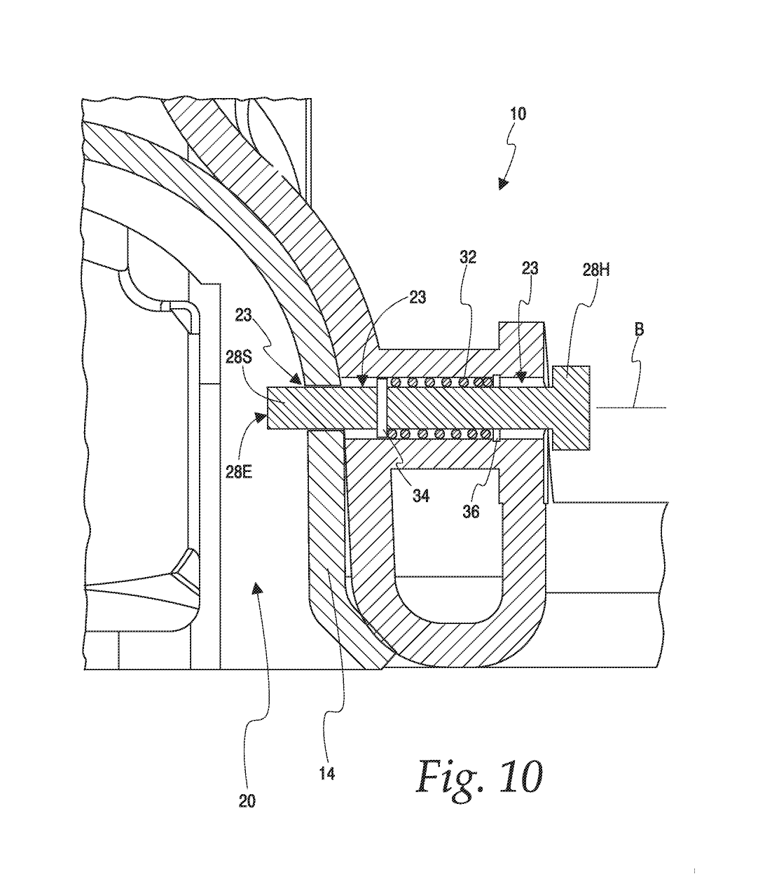

### DETAILED DESCRIPTION OF THE DRAWINGS

The drawings illustrate a trailer coupler 10 for use with a hitch ball 12. The coupler 10 includes a coupler body 14, a latch 16, and a latch operating lever 18. The coupler body defines a cavity 20 configured to selectively receive the hitch ball 12 therein. As will be discussed further below, first and second indicator pin guides 22, 24, extend from the coupler body 14. First and second indicator pins 26, 28 are slidingly received within apertures defined by the first and second apertures 22, 24 and corresponding portions of the coupler body 14, respectively.

The hitch ball 12 can be of any conventional nominal size, for example, a 1⅞ inch, 2 inch, or 2⅝ inch diameter, or another nominal size. A shank 13 is integral with and extends from the hitch ball 12. The shank 13 has a lesser diameter than the hitch ball 12. The free end of the shank 13 may be configured for attachment to a ball mount, as would be understood by one skilled in the art.

The cavity 20 of the coupler 10 has the same nominal size as the hitch ball 12, as would be understood by one skilled in the art. The cavity 20 includes a generally hemispherical portion configured to be supported by the hitch ball 12 when in use, as would be understood by one skilled in the art. The cavity is configured to selectively receive the hitch ball 12 along an insertion axis A, as would be recognized by one skilled in the art.

The latch 16 is slidingly or otherwise movably disposed within the coupler body 14. The latch 16 is pivotally connected to or otherwise pivotally engaged with the latch operating lever 18. The latch operating lever 18 is pivotally connected to or pivotally engaged with the coupler body 14. The latch 16, the latch operating lever 18, and the coupler body 14 are interconnected and/or inter-engaged so that pivoting of the latch operating lever 18 in a first direction causes the latch 16 to move toward (or inwardly with respect to) the cavity 20, and pivoting of the latch operating lever 18 in a second direction opposite the first direction causes the latch 16 to move away from (or outwardly with respect to) the cavity 20.

The latch 16 defines a free end 30. The free end 30 defines a curve having a diameter complementary to the diameter of the hitch ball 12. The latch 16 is movable between a first (or open) position wherein the free end 30 thereof is sufficiently retracted from the cavity 20 to enable insertion and removal of the hitch ball 12 past the latch 16 and fully into and from the cavity 20, and a second (or closed) position wherein the free end of the latch is sufficiently extended into the cavity to preclude insertion or removal of the hitch ball 12 into or from the cavity 20. With the hitch ball 12 inserted into the cavity 20 and the latch 18 in the closed position, the free end 30 of the latch may engage with or bear against the hitch ball 12 generally adjacent the shank 13, thereby precluding the hitch ball 12 from being removed from the cavity.

As set forth above, the first and second indicator pin guides 22, 24 and corresponding portions of the coupler body 14 define respective first and second apertures 23, 25 extending therethrough. The first aperture 23 defines a first aperture axis B substantially perpendicular to the insertion axis A. Similarly, the second aperture 25 defines a second aperture axis C substantially perpendicular to the insertion axis A. The first and second aperture axes B, C may be, but need not be, co-linear. The location of each of the first and second aperture axes B, C corresponds to the location of a circumference of the hitch ball 12 when the hitch ball is fully inserted into the cavity 20.

The first indicator pin 26 includes a shaft 26S and a travel stop in the form of a head 26H connected to and extending axially and radially from the corresponding end of the shaft. The first indicator pin 26 also includes a free end opposite the head 26H. The second indicator pin 28 may be similarly configured.

The first indicator pin 26 is sliding received within the first indicator pin guide 22. The free end 26E of the first indicator pin 26 is selectively extendable into and retractable from the cavity 20. Interaction between the head 26H of the first indicator pin 26 and the outer end of the first indicator pin guide 22 limits the extent of travel of the free end 26E of the first indicator pin 26 into the cavity 20. The second indicator pin may be similarly received within the second indicator pin guide 24.

A biasing mechanism biases the free end of the first indicator 26 pin into the cavity 20. As shown, the biasing mechanism includes a coil compression spring 32 disposed about the shaft 26S of the first indicator pin 26. A first end of the spring 32 bears against a first spring seat 34 fixed to the first indicator pin 26. A second end of the spring 32 bears against a second spring seat 36 fixed to the first indicator pin guide 22. A similar biasing mechanism may similarly bias the free end 28E of the second indicator 28 pin into the cavity 20.

In use, with no hitch ball inserted into the cavity 20, the free ends 26E, 28E of the first and second indicator pins 26, 28 are biased into the cavity 20, and the respective heads 26H, 28H abut the outer ends of the first and second indicator pin guides 22, 24. Upon installation of a hitch ball 12 into the cavity 20, the hitch ball, if sufficiently large, initially contacts the free end 26E, 28E of one or both of the first and second indicator pins 26, 28 in bearing engagement therewith, and displaces the free ends outwardly from the cavity. Consequently, the corresponding heads 26H, 28H are displaced away from the outer ends of the respective indicator pin guides 22, 24.

If the hitch ball 12 is properly sized for the coupler 10, both of the first and second indicator pins 26, 28 will be displaced a predetermined amount from their initially retracted positions, thereby indicating to a user that the hitch ball 12 is properly sized for the coupler and is fully inserted into the coupler. The first and second indicator pins 26, 28 may include a visual element 26V, 28V thereon or incorporated therein to indicate the amount of extension. The visual element may be a color-coded or other go/no-go element. For example, the visual element may take the form of a green marking disposed on the shaft 26S, 28S of each of the first and second indicator pin 26, 28 that is visible only when the respective pin has been extended the predetermined amount of extension. A corollary visual element (not shown), for example, a red marking disposed on the shaft 26S, 28S of each of the first and second indicator pins 26, 28 between the green marking and the head 26H, 28H of the respective pin, could be provided to indicate insufficient extension of the respective pin.

If the hitch ball 12 is undersized for the coupler 10, the hitch ball 12 may fail to make contact with either or both of the first and second indicator pins 26, 28 when the hitch ball is inserted into the cavity 20, or it may not displace either or both of the first and second indicator pins by the predetermined amount of extension. In this instance, at least one of the first and second indicator pins 26, 28 will not be displaced by the predetermined amount, thus indicating to the user that the hitch ball 12 is undersized for the cavity 20.

Also, if the hitch ball 12 is properly sized for the cavity 20, but is not fully inserted into the cavity, at least one of the first and second indicator pins 26, 28 will not be displaced by the predetermined amount of extension, thus indicating to the user that the hitch ball is not fully inserted into the cavity.

The embodiments disclosed herein are illustrative and not limiting. The scope of the invention is limited solely by the appended claims.

1. A hitch ball-type trailer coupler comprising:
a coupler body defining a cavity configured to receive a nominally-sized hitch ball;
a first indicator pin guide operably associated with the coupler body, the first indicator pin guide in communication with the cavity;
a second indicator pin guide operably associated with the coupler body, the second indicator pin guide in communication with the cavity;
a first indicator pin slidably received in the first indicator pin guide, the first indicator pin movable between a retracted position and an extended position with respect to the coupler body;
a first biasing mechanism biasing the first indicator pin to the retracted position;
a second indicator pin slidably received in the second indicator pin guide, the second indicator pin movable between a retracted position and an extended position with respect to the coupler body; and
a second biasing mechanism biasing the second indicator pin to the retracted position.

2. The coupler of claim 1 wherein at least one of the first indicator pin and the second indicator pin comprises a visual element representing a degree of extension of the respective indicator pin with respect to the coupler body.

3. The coupler of claim 2 wherein the visual element comprises a marking indicating a predetermined degree of extension of the respective indicator pin with respect to the coupler body, wherein the predetermined degree of extension is a function of the nominal size of the nominally-sized hitch ball.

4. The coupler of claim 3 wherein the marking comprises one or more colors indicating a degree of extension greater than, equal to, or less than the predetermined degree of extension.

5. The coupler of claim 1 wherein each of the first indicator pin and the second indicator pin includes a first end configured for selective contact with a hitch ball inserted into the cavity.

6. The coupler of claim 5 configured such that insertion of the nominally-sized hitch ball into the cavity causes extension of both of the first and second indicator pins by at least a predetermined degree of extension.

7. The coupler of claim 5 configured such that insertion of a hitch ball of a lesser nominal diameter than the nominally-sized hitch ball into the cavity does not cause extension of at least one of the first and second indicator pins by at least the predetermined degree of extension.

8. The coupler of claim 1 further comprising at least one retainer operably associated with at least one of the first indicator pin and the second indicator pin, the at least one retainer limiting the degree of extension and retraction of the respective indicator pin.

9. The coupler of claim 1 in combination with the nominally-sized hitch ball.

10. The coupler of claim 3 in combination with the nominally-sized hitch ball.

11. The coupler of claim 5 in combination with the nominally-sized hitch ball.

12. The coupler of claim 6 in combination with the nominally-sized hitch ball.

13. The coupler of claim 7 in combination with the nominally-sized hitch ball.

14. The coupler of claim 9 wherein the nominally-sized hitch ball is inserted into the cavity.

15. The coupler of claim 14 wherein the first and second indicators are extended to at least a predetermined degree of extension, wherein the predetermined degree of extension is a function of the nominal size of the nominally-sized hitch ball.

16. The coupler of claim 1 further including a first biasing mechanism biasing the first indicator pin toward the cavity of the coupler body.

17. The coupler of claim 14 further including a first biasing mechanism biasing the first indicator pin toward the cavity of the coupler body.
